(19) United States
(12) Patent Application Publication
(10) Pub. No.: US 2017/0335712 A1
(43) Pub. Date: Nov. 23, 2017

(54) VARIABLE AREA VANE HAVING MINIMIZED END GAP LOSSES

(71) Applicant: United Technologies Corporation, Farmington, CT (US)

(72) Inventors: Pitchaiah Vijay Chakka, Avon, CT (US); Eric A. Grover, Tolland, CT (US); John D. Teixeira, Palm City, FL (US)

(21) Appl. No.: 15/161,436

(22) Filed: May 23, 2016

(51) Int. Cl. F01D 17/16; F01D 9/04

(52) U.S. Cl. CPC F01D 17/162; F01D 9/041; F05D 2220/32; F05D 2240/30; F05D 2240/12

(57) ABSTRACT

Airfoils are provided having a body having a leading edge, a trailing edge, a first end surface, and a second end surface opposite the first end surface, wherein (i) a first true chord length is a line extending from a first leading edge point to a first trailing edge point and (ii) a second true chord length is a line extending from a second leading edge point to a second trailing edge point, a first button located on the first end surface of the airfoil body, the first button having a first diameter and a first attachment device extending from the first button to enable rotation of the airfoil body about an attachment device axis. The first diameter is at least 15% of the first true chord length or the attachment device axis is located 10% of the first true chord length from the leading edge point.

### STATEMENT REGARDING FEDERALLY SPONSORED RESEARCH OR DEVELOPMENT

This invention was made with government support under Contract No. N00014-09-D-0821-0006 awarded by the U.S. Navy. The government has certain rights in the invention.

### BACKGROUND

The subject matter disclosed herein generally relates to gas turbine engines and, more particularly, to variable area vanes having minimized end gap losses for gas turbine engines.

In variable area turbines, throat area variation is achieved by incorporating rotating vanes. The vanes are rotated with an attachment device and button assembly (e.g., spindle and button assembly). This attachment device-button feature is designed to enable rotation of the vane to open and close the vane during operation. The attachment device is configured to define an attachment device axis about which the vane can rotate. The variable area vanes have end gaps between the vane and end-walls of a flow path through a gas turbine engine. The end gaps enable flow to leak from a pressure side to a suction side of the vane and may be a source of losses for variable area turbines.

### SUMMARY

According to one embodiment, an airfoil for a gas turbine engine is provided. The airfoil includes an airfoil body having a leading edge, a trailing edge, a first end surface extending from the leading edge to the trailing edge, and a second end surface extending from the leading edge to the trailing edge and opposite the first end surface, wherein (i) a first true chord length is defined as a linear distance along the first end surface from a first leading edge point located at an intersection of the first end surface and the leading edge to a first trailing edge point located at an intersection of the first end surface and the trailing edge and (ii) a second true chord length is defined as a linear distance from a second leading edge point located at an intersection of the second end surface and the leading edge to a second trailing edge point located at an intersection of the second end surface and the trailing edge, a first button located on the first end surface of the airfoil body, the first button having a first diameter and configured to fit within a first recess of a flow path of a gas turbine engine, and a first attachment device extending from the first button and configured to attach to the gas turbine engine and enable rotation of the airfoil body about an attachment device axis that extends through the first attachment device, the first button, and the airfoil body, wherein the airfoil body is rotatable about the attachment device axis. The length of the first diameter is at least 15% of the first true chord length.

In addition to one or more of the features described above, or as an alternative, further embodiments of the airfoil may include a second button located on the second end surface of the airfoil body, the second button having a second diameter and configured to fit within a second recess of the flow path of the gas turbine engine and a second attachment device extending from the second button. The attachment device axis extends through the second button and the second attachment device.

In addition to one or more of the features described above, or as an alternative, further embodiments of the airfoil may include that the second diameter is at least 15% of the second true chord length.

In addition to one or more of the features described above, or as an alternative, further embodiments of the airfoil may include that the attachment device axis has a location on the second end surface of the airfoil body a distance along the second true chord length from the leading edge point that is at least 10% of the second true chord length.

In addition to one or more of the features described above, or as an alternative, further embodiments of the airfoil may include that the first diameter is greater than the second diameter.

In addition to one or more of the features described above, or as an alternative, further embodiments of the airfoil may include that the attachment device axis is located on the first end surface of the airfoil body a distance along the first true chord length from the leading edge point that is at least 10% of the first true chord length.

In addition to one or more of the features described above, or as an alternative, further embodiments of the airfoil may include that the airfoil body, the first button, and the first attachment device are an integral component.

In addition to one or more of the features described above, or as an alternative, further embodiments of the airfoil may include that the first true chord length is equal to the second true chord length.

According to another embodiment, an airfoil for a gas turbine engine is provided. The airfoil includes an airfoil body having a leading edge, a trailing edge, a first end surface extending from the leading edge to the trailing edge, and a second end surface extending from the leading edge to the trailing edge and opposite the first end surface, wherein (i) a first true chord length is defined as a linear distance along the first end surface from a first leading edge point located at an intersection of the first end surface and the leading edge to a first trailing edge point located at an intersection of the first end surface and the trailing edge and (ii) a second true chord length is defined as a linear distance from a second leading edge point located at an intersection of the second end surface and the leading edge to a second trailing edge point located at an intersection of the second end surface and the trailing edge, a first button located on the first end surface of the airfoil body, the first button having a first diameter and configured to fit within a first recess of a flow path of a gas turbine engine, and a first attachment device extending from the first button and configured to attach to the gas turbine engine and enable rotation of the airfoil body about an attachment device axis that extends through the first attachment device, the first button, and the airfoil body, wherein the airfoil body is rotatable about the attachment device axis. The attachment device axis is located on the first end surface of the airfoil body a distance along the first true chord length from the leading edge point that is at least 10% of the first true chord length.

In addition to one or more of the features described above, or as an alternative, further embodiments of the airfoil may include a second button located on the second end surface of the airfoil body, the second button having a second diameter and configured to fit within a second recess of the flow path of the gas turbine engine and a second attachment device extending from the second button. The attachment device axis extends through the second button and the second attachment device.

In addition to one or more of the features described above, or as an alternative, further embodiments of the airfoil may include that the attachment device axis has a location on the second end surface of the airfoil body a distance along the second true chord length from the second leading edge point that is at least 10% of the second true chord length.

In addition to one or more of the features described above, or as an alternative, further embodiments of the airfoil may include that the airfoil body, the first button, and the first attachment device are an integral component.

In addition to one or more of the features described above, or as an alternative, further embodiments of the airfoil may include that the first diameter is greater than the second diameter.

In addition to one or more of the features described above, or as an alternative, further embodiments of the airfoil may include that the first true chord length is equal to the second true chord length.

According to another embodiment, a gas turbine engine is provided. The gas turbine engine includes a variable area turbine having a variable area vane. The vane has an airfoil body having a leading edge, a trailing edge, a first end surface extending from the leading edge to the trailing edge, and a second end surface extending from the leading edge to the trailing edge and opposite the first end surface, wherein (i) a first true chord length is defined as a linear distance along the first end surface from a first leading edge point located at an intersection of the first end surface and the leading edge to a first trailing edge point located at an intersection of the first end surface and the trailing edge and (ii) a second true chord length is defined as a linear distance from a second leading edge point located at an intersection of the second end surface and the leading edge to a second trailing edge point located at an intersection of the second end surface and the trailing edge, a first button located on the first end surface of the airfoil body, the first button having a first diameter and configured to fit within a first recess of a flow path of a gas turbine engine, and a first attachment device extending from the first button and configured to attach to the gas turbine engine and enable rotation of the airfoil body about an attachment device axis that extends through the first attachment device, the first button, and the airfoil body, wherein the airfoil body is rotatable about the attachment device axis. The length of the first diameter is at least 15% of the first true chord length.

In addition to one or more of the features described above, or as an alternative, further embodiments of the gas turbine engine may include a second button located on the second end surface of the airfoil body, the second button having a second diameter and configured to fit within a second recess of the flow path of the gas turbine engine and a second attachment device extending from the second button. The attachment device axis extends through the second button and the second attachment device.

In addition to one or more of the features described above, or as an alternative, further embodiments of the gas turbine engine may include that the second diameter is at least 15% of the second true chord length.

In addition to one or more of the features described above, or as an alternative, further embodiments of the gas turbine engine may include that the attachment device axis has a location on the second end surface of the airfoil body a distance along the second true chord length from the leading edge point that is at least 10% of the second true chord length.

In addition to one or more of the features described above, or as an alternative, further embodiments of the gas turbine engine may include that the first diameter is greater than the second diameter.

In addition to one or more of the features described above, or as an alternative, further embodiments of the gas turbine engine may include that the attachment device axis is located on the first end surface of the airfoil body a distance along the first true chord length from the leading edge point that is at least 10% of the first true chord length.

According to another embodiment, a gas turbine engine is provided. The gas turbine engine includes a variable area turbine having a variable area vane. The vane includes an airfoil body having a leading edge, a trailing edge, a first end surface extending from the leading edge to the trailing edge, and a second end surface extending from the leading edge to the trailing edge and opposite the first end surface, wherein (i) a first true chord length is defined as a linear distance along the first end surface from a first leading edge point located at an intersection of the first end surface and the leading edge to a first trailing edge point located at an intersection of the first end surface and the trailing edge and (ii) a second true chord length is defined as a linear distance from a second leading edge point located at an intersection of the second end surface and the leading edge to a second trailing edge point located at an intersection of the second end surface and the trailing edge, a first button located on the first end surface of the airfoil body, the first button having a first diameter and configured to fit within a first recess of a flow path of a gas turbine engine, and a first attachment device extending from the first button and configured to attach to the gas turbine engine and enable rotation of the airfoil body about an attachment device axis that extends through the first attachment device, the first button, and the airfoil body, wherein the airfoil body is rotatable about the attachment device axis. The attachment device axis is located on the first end surface of the airfoil body a distance along the first true chord length from the leading edge point that is at least 10% of the first true chord length.

Technical effects of embodiments of the present disclosure include variable area vanes with decreased end gap losses. Further technical effects include variable area vanes having increased diameter buttons that are configured to minimize end gap losses. Further technical effects include variable area vanes having spindle axis locations configured to minimize end gap losses.

The foregoing features and elements may be executed or utilized in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic cross-sectional illustration of a gas turbine engine that may employ various embodiments disclosed herein;

FIG. 1B is a schematic illustration of a turbine section that may employ various embodiments disclosed herein;

FIG. 2 is a schematic illustration of a portion variable area turbine in accordance with an embodiment of the present disclosure;

FIG. 3A is a schematic illustration of a variable area airfoil in accordance with an embodiment of the present disclosure; and

FIG. 3B is a schematic illustration of the airfoil of FIG. 3A as viewed along the line B-B of FIG. 3A.

### DETAILED DESCRIPTION

As shown and described herein, various features of the disclosure will be presented. Various embodiments may have the same or similar features and thus the same or similar features may be labeled with the same reference numeral, but preceded by a different first number indicating the Figure Number to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

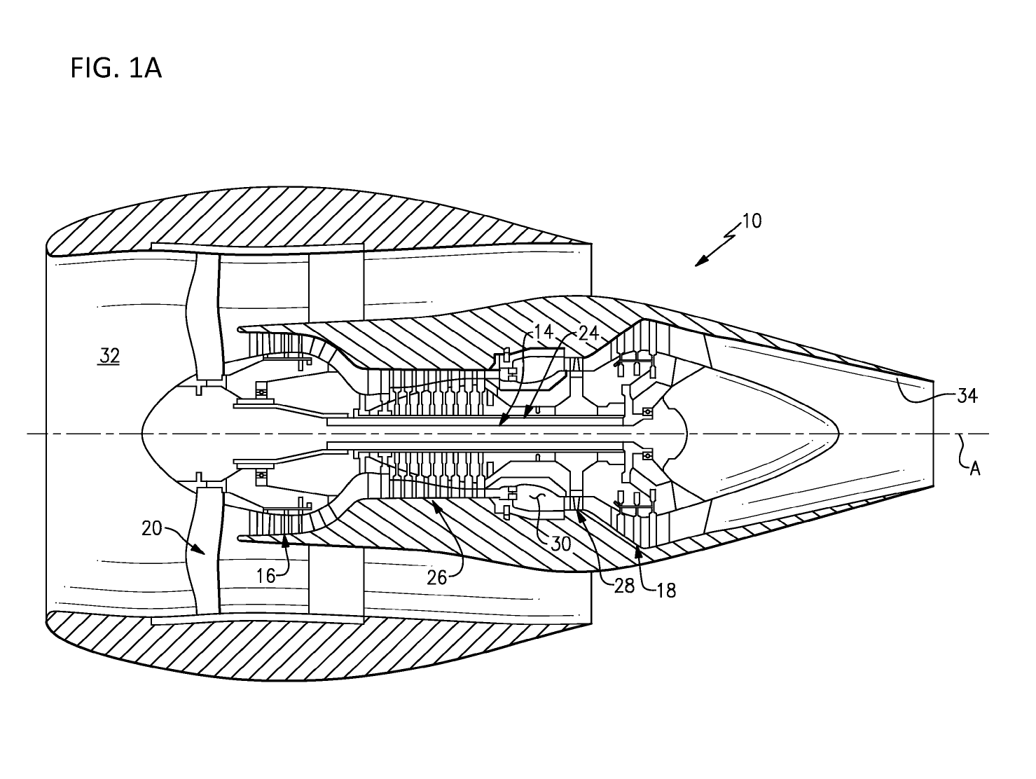

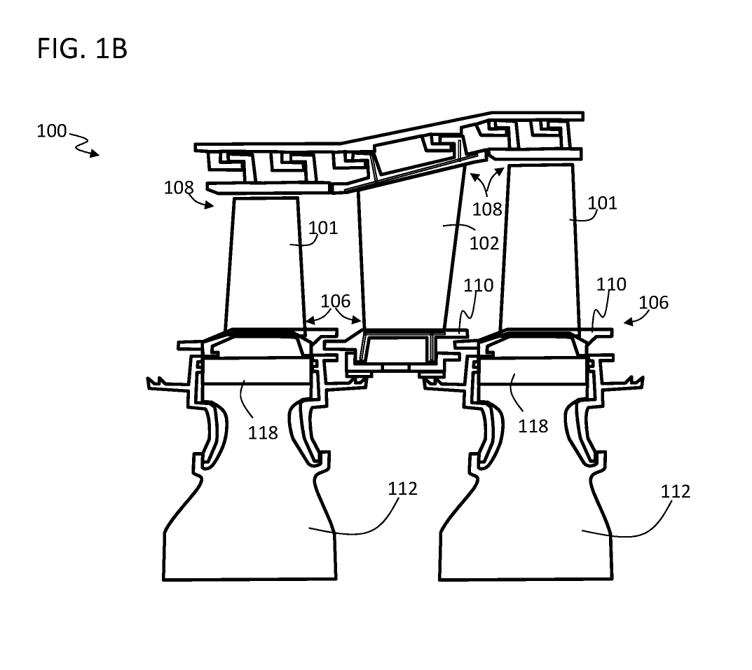

FIG. 1A illustrates a general schematic view of a gas turbine engine 10 such as a gas turbine engine for propulsion. While a particular turbofan engine is schematically illustrated in the disclosed non-limiting embodiment, it should be understood that the disclosure is applicable to other gas turbine engine configurations, including, for example, gas turbines for power generation, turbojet engines, low bypass turbofan engines, turboshaft engines, etc.

The engine 10 includes a core engine section that houses a low spool 14 and high spool 24. The low spool 14 includes a low pressure compressor 16 and a low pressure turbine 18. The core engine section drives a fan section 20 connected to the low spool 14 either directly or through a gear train. The high spool 24 includes a high pressure compressor 26 and high pressure turbine 28. A combustor section 30 is arranged between the high pressure compressor 26 and high pressure turbine 28. The low spool 14 and high spool 24 rotate about an axis of rotation A of the engine 10.

The gas turbine engine 10 functions in a conventional manner, as known in the art. Air drawn through an intake 32 is accelerated by the fan section 20 and divided along a bypass flow path and a core flow path. The bypass flow path bypasses the core engine section and is exhausted to atmosphere to provide propulsive thrust. The core flow path compresses the air in the low pressure compressor 16 and the high pressure compressor 26 and is mixed with fuel to be combusted in the combustor section 30. The resultant hot combustion products then expand through, and thereby drive the low pressure turbine 18 and the high pressure turbine 28 before being exhausted to atmosphere through an exhaust nozzle 34 to provide additional propulsive thrust. The low pressure turbine 18 and the high pressure turbine 28, in response to the expansion, drive the respective low pressure compressor 16 and high pressure compressor 26 and fan section 20.

FIG. 1B is a schematic view of a turbine section that may employ various embodiments disclosed herein. Turbine 100 includes a plurality of airfoils, including, for example, one or more blades 101 and vanes 102. The airfoils 101, 102 extend from an inner diameter 106 to an outer diameter 108 within an air flow path. The blades 101 and the vanes 102 can include platforms 110 located proximal to the inner diameter 106 thereof. A root or attachment 118 of the airfoils 101 can be connected to or be part of the platform 110. The platform 110, as shown, is mounted to an attachment 118 of a turbine disk 112.

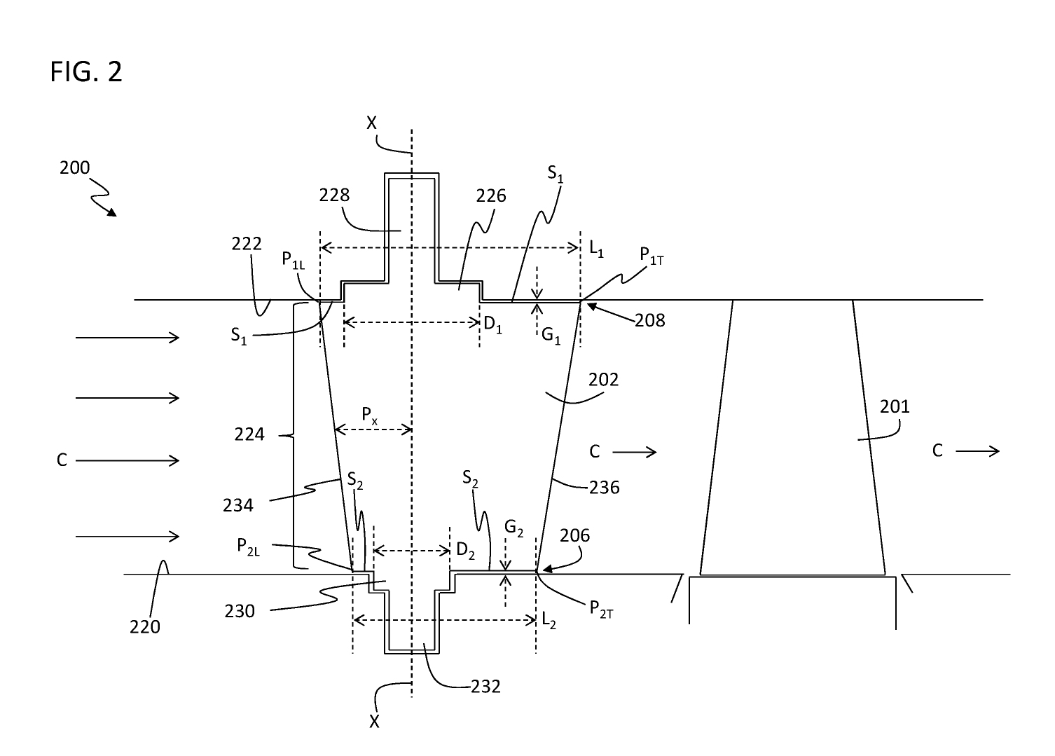

Turning now to FIG. 2, a schematic illustration of an airfoil in accordance with a non-limiting embodiment of the present disclosure is shown. In FIG. 2, a vane 202 is located within a portion of a turbine 200. The vane 202 is a variable area vane that is configured to rotate within a flow path C to thus control a variable flow through the flow path C. As shown, a blade 201 is located downstream from the vane 202. The flow path C is defined, in part, between an inner diameter end wall 220 and an outer diameter end wall 222. The end walls 220, 222 can be formed from part of the turbine 200 and may include, in some embodiments, vane rings that are configured to support the vane 202 at an inner diameter and an outer diameter of the vane 202.

In variable area turbines, such as turbine 200, a throat area variation is achieved by incorporating rotating vanes similar to vane 202. The vane 202 is rotated with an attachment device-button assembly that extends from an airfoil body 224. For example, in some embodiments, the attachment device-button assembly may be configured as a spindle-button assembly. The attachment device-button assembly is designed for inner diameter 206 and outer diameter 208 rotation about an attachment device axis X, as shown in FIG. 2. The attachment device-button assembly, in the embodiment shown in FIG. 2, includes an inner portion and an outer portion. For example, as shown in FIG. 2, the vane 202 includes a first button 226 and a first attachment device 228 located at an outer diameter 208 of the vane 202. Similarly, the vane 202 includes second button 230 and a second attachment device 232 located at an inner diameter 206 of the vane 202. As shown, the airfoil body 224 is located within the flow path C and the portions of the attachment device-button assembly (e.g., buttons 226, 230; attachment devices 228, 232) extend into the end walls 220, 222 of the turbine 200.

As shown in FIG. 2, the vane 202 has a first true chord length L₁ at the outer diameter 208 of the vane 202. As used herein, the true chord length is a linear length extending from a leading edge point to a trailing edge point of the airfoil at a specific span-wise location. The leading edge point and the trailing edge point of a single true chord length at a position in the span-wise direction of an airfoil defines a constant or fixed length. For example, the leading edge point and the trailing edge point can be points at a span-wise position along the span of the airfoil where a camber line exits the leading edge and trailing edge, respectively. Stated another way, the leading edge point and the trailing edge point are points at a span-wise position along the leading edge and the trailing edge of the airfoil where the radius of curvature of the edges is the smallest. Those of skill in the art will appreciate that, in FIG. 2, the span-wise direction is a length/direction of the vane 202 extending from the inner diameter 206 to the outer diameter 208.

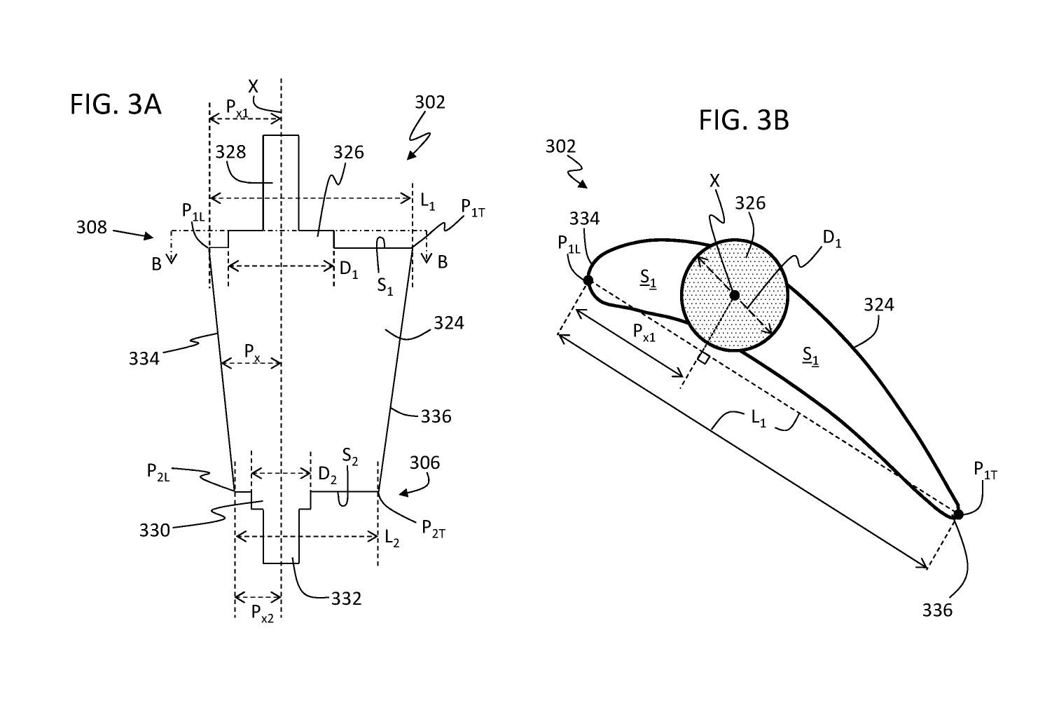

In the configuration shown in FIG. 2, a first leading edge point P_{1L} is located at a junction or intersection of a leading edge 234 of the airfoil 202 and a first end surface S₁ of the airfoil 202 (e.g., at the outer diameter 208). For example, see FIG. 3B, providing a top-down, plan illustration of an airfoil. Similarly, a first trailing edge point P_{1T} is located at a junction or intersection of a trailing edge 236 of the airfoil 202 and the first end surface S₁ (e.g., at the outer diameter 208). Further, a second leading edge point P_{2L} is located at a junction or intersection of a leading edge 234 of the airfoil 202 and a second end surface S₂ of the airfoil 202 (e.g., at the inner diameter 206), as shown, and a second trailing edge point P_{2T} is located at a junction or intersection of a trailing edge 236 of the airfoil 202 and the second end surface of S₂ (e.g., at the inner diameter 206).

At the inner diameter 208 of the vane 202, as shown, the vane 202 has a second true chord length L₂. The first and second true chord lengths L₁, L₂ are the linear length of the vane 202 from (i) the leading edge point P_{1L} to the trailing edge point P_{1T} and (ii) the leading edge point P_{2L} to the trailing edge point P_{2T}, respectively. That is, the first true chord length L₁ and the second true chord length L₂ are straight line lengths from the respective leading edge points to the respective trailing edge points.

As shown in FIG. 2, the first true chord length L₁ is greater than the second true chord length L₂. Accordingly, the true chord length of the vane from the respective leading edge points to the respective trailing edge points can be different in length at different span-wise positions along the airfoil. Because of the different true chord lengths of the vane 202, as shown in FIG. 2, an attachment device axis position P, of the attachment device axis X is different relative to or with respect to the leading edge 234 along the span-wise direction. Those of skill in the art will appreciate that, on a span-wise or section basis, the true chord length is always fixed.

In the embodiment of FIG. 2, the attachment device axis position P, increases in dimension (e.g., length, distance, dimension) as the position P, extends from the inner diameter 206 to the outer diameter 208 of the vane 202. Although shown with a specific configuration in FIG. 2, those of skill in the art will appreciate that other vane configurations are possible without departing from the scope of the present disclosure. For example, in some embodiments, the first true chord length can be less than the second true chord length, and in other embodiments the first true chord length can be equal to the second true chord length along the span of the airfoil (e.g., a constant true chord length along the span of the airfoil).

Further, as shown, the first button 226 of the vane 202 has a first diameter D₁ and the second button 230 has a second diameter D₂. The first diameter D₁, in the embodiment of FIG. 2, is greater than the second diameter D₂. The buttons 226, 230 are thus round buttons with a uniform diameter that are configured to enable the vane 202 to rotate within the flow path C about the attachment device axis X. The buttons 226, 230 are configured to fit within a recess or other cavity in the end walls 220, 222 of the flow path C. Similarly, the attachment devices 228, 232 are round (although other geometries and/or shapes can be used) and are configured and engageable to rotate the vane 202.

Also shown in FIG. 2, the variable area vane 202 defines end gaps between the vane 202 and the end walls 220, 222 (both inner and outer diameter end walls). As shown, a first end gap G₁ is formed between the vane 202 at the outer diameter 208 and the outer end wall 222, and a second end gap G₂ is formed between the vane 202 at the inner diameter 206 and the inner end wall 220. The height of the end gaps G₁, G₂ is defined as a distance between an exposed or end surface S₁, S₂ of the vane 202 and an end wall (e.g., 220, 222) of the flow path C, and a length of the end gaps G₁, G₂ is defined as a distance between a leading edge point P_{1L}, P_{2L}, or a trailing edge point P_{1T}, P_{2T} and an edge of a respective button 226, 223.

The end gaps G₁, G₂ allow flow to leak from a pressure side to a suction side of the vane 202 and are thus a source of additional losses for variable area turbines. As shown in FIG. 2, the end gaps G₁, G₂, are formed between the buttons 226, 230 and the trailing edge 236 of the vane 202. In some embodiments, the buttons 226, 230 can be integrally formed with and are part of the vane 202 which can result in no end gap existing at the location of the buttons 226, 230. By selecting a size and/or position of the buttons in the attachment device-button assemblies, the amount of gap can be minimized.

Embodiments of the present disclosure are directed to attachment device-buttons assembly features that are configured to reduce end gap losses. For example, the buttons 226, 230 are sized and configured to reduce the end gaps G₁, G₂. As noted, the end gaps G₁, G₂ for a rotating vane in a variable area turbine can be the source of aerodynamic loss. The end gaps G₁, G₂ can be reduced by increasing a button diameter (e.g., diameters D₁, D₂) and/or by moving the attachment device axis X as aft as possible from the leading edge 234 of the vane 202. The combination (or individual design features) of attachment device axis location and increased button diameter can close the gap near the trailing edge 236 of the airfoil 202 (e.g., where the leakage losses can be high).

Although show and described with respect to a specific or particular airfoil shape, geometry, and configuration, those of skill in the art will appreciate that embodiments provided herein can be employed with airfoil having different configurations. For example, curved airfoils, variable airfoils, etc., can all be configured with embodiments of the present disclosure.

Turning now to FIGS. 3A-3B, schematic illustrations of a vane 302 in accordance with a non-limiting embodiment of the present disclosure are shown. FIG. 3A shows a side elevation view of the vane 302 and FIG. 3B shows a top-down view of the vane 302 along the line B-B of FIG. 3A. The vane 302 is similar to that shown and described with respect to FIG. 2. Accordingly, the vane 302 is a variable area vane for a variable area turbine. The vane 302 includes an airfoil body 324 that extends from a leading edge 334 to a trailing edge 336, with a first end surface S₁ and a second end surface S₂. As shown, the airfoil body 324 can be curved to form a desired airfoil shape. Although a particular airfoil geometry is shown, those of skill in the art will appreciate that other geometries, shapes, curvatures, dimensions, etc., can employ embodiments of the present disclosure, and the illustrations are not to be limiting.

The vane 302 includes a first button 326 and a respective first attachment device 328, as shown at an outer diameter 308 of the vane 302. The vane 302 also includes a second button 330 and a respective second attachment device 332, as shown at an inner diameter 306 of the vane 302. An attachment device axis X extends through the vane 302 from the first attachment device 328 to the second attachment device 332 and defines an axis of rotation for the vane 302.

Similar to the configuration of FIG. 2, the first button 326 has a first diameter D₁ and the vane 302 has a first true chord length L₁, as show at the outer diameter 308. The second button 330 has a second diameter D₂ and the vane 302 has an second true chord length L₂, as shown at the inner diameter 306. As described above, the true chord lengths L₁, L₂ are linear lengths that extend from leading edge points P_{1L}, P_{2L} on the leading edge 334 to respective trailing edge points P_{1T}, P_{2T} on the trailing edge 336 of the airfoil 302.

Also shown in the embodiment of FIG. 3A, an attachment device axis position P, of the attachment device axis X is variable extending from the inner diameter 306 to the outer diameter 308. Although shown with increasing attachment device axis position P, from the inner diameter 306 to the outer diameter 308, those of skill in the art will appreciate that the attachment device axis position P, can be increasing from the outer diameter 308 to the inner diameter 306, can be constant from the inner diameter 306 to the outer diameter 308, or some other geometric configuration (e.g., increasing distance toward the inner and outer diameters from a point between). The attachment device axis position P, is a distance of the attachment device axis X from the leading edge along the true chord length from the leading edge. For example, as shown in FIG. 3B, the attachment device axis position Pₓ₁ defines a distance of the attachment device axis X at the first button 326. This position or distance is defined as a length along the first true chord length L₁ to a point where a normal or 90° line is drawn from the attachment device axis X through the first true chord length L₁ (e.g., as shown in FIG. 3B).

In accordance with some embodiments, the relationship between the diameters D₁, D₂ of the buttons 326, 330 and the true chord lengths L₁, L₂ of the vane 302 can impact the leakage losses at the end gaps (e.g., end gaps G₁, G₂, shown in FIG. 2). For example, in accordance with some non-limiting embodiments, the diameters D₁, D₂ of the buttons 326, 330 can be 15% or greater in dimension of the respective true chord length Lᵢ, Lₒ of the vane 302. That is, the first diameter D₁ of the first button 326 is a length or dimension that is 15% or greater of the first true chord length L₁. Similarly, the second diameter D₂ of the second 330 is a length or dimension that is 15% or greater of the length or dimension of the second true chord length L₂. By configuring the buttons 326, 330 with a diameter that is 15% or greater than a respective true chord length L₁, L₂, the end gaps can be reduced, and thus end gap losses can be minimized. Stated another way, by having button diameters with such dimensions, a surface area of the first end surface S₁ of the airfoil 302 can be minimized or reduced and thus limiting the amount of end gap losses (e.g., as shown in FIG. 3B)

Another factor that can impact the amount of end gap losses can be the location or distance of the attachment device axis position P, from the leading edge 334. The location of the attachment device axis position P, of the attachment device axis X defines the positions of the buttons 326, 330, because the buttons 326, 330 are located between the attachment devices 328, 332 along the attachment device axis X. As shown, the first button 326 can have a first button position Pₓ₁ relative to the first leading edge point P_{1L} and the second button 330 can have a second button position Pₓ₂ relative to the second leading edge point P_{2L}. In accordance with embodiment of the present disclosure, the button positions Pₓ₁, Pₓ₂ can be 10% or greater than the respective true chord length L₁, L₂.

Advantageously, embodiments provided herein enable covering of an end gap of a variable area vane of a gas turbine engine to decrease losses due to end gaps of the vanes. For example, various embodiments provide an increased diameter button that reduces the amount of exposed vane surface area of end surfaces to form an end gap, thus reducing the end gap losses. Further, embodiments provided herein include a variable area vane having an attachment device axis location that is aftward (as compared to prior vane configurations), which can reduce the amount of end gap that is formed between the vane and an end wall of a flow path in a gas turbine engine.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

For example, although an aero or aircraft engine application is shown and described above, those of skill in the art will appreciate that turbine disk configurations as described herein may be applied to industrial applications and/or industrial gas turbine engines, land based or otherwise.

Accordingly, the present disclosure is not to be seen as limited by the foregoing description, but is only limited by the scope of the appended claims.

What is claimed is:

1. An airfoil for a gas turbine engine, the airfoil comprising:
an airfoil body having a leading edge, a trailing edge, a first end surface extending from the leading edge to the trailing edge, and a second end surface extending from the leading edge to the trailing edge and opposite the first end surface, wherein (i) a first true chord length is defined as a linear distance along the first end surface from a first leading edge point located at an intersection of the first end surface and the leading edge to a first trailing edge point located at an intersection of the first end surface and the trailing edge and (ii) a second true chord length is defined as a linear distance from a second leading edge point located at an intersection of the second end surface and the leading edge to a second trailing edge point located at an intersection of the second end surface and the trailing edge;
a first button located on the first end surface of the airfoil body, the first button having a first diameter and configured to fit within a first recess of a flow path of a gas turbine engine; and
a first attachment device extending from the first button and configured to attach to the gas turbine engine and enable rotation of the airfoil body about an attachment device axis that extends through the first attachment device, the first button, and the airfoil body, wherein the airfoil body is rotatable about the attachment device axis,
wherein the length of the first diameter is at least 15% of the first true chord length.

2. The airfoil of claim 1, further comprising:
a second button located on the second end surface of the airfoil body, the second button having a second diameter and configured to fit within a second recess of the flow path of the gas turbine engine; and
a second attachment device extending from the second button,
wherein the attachment device axis extends through the second button and the second attachment device.

3. The airfoil of claim 2, wherein the second diameter is at least 15% of the second true chord length.

4. The airfoil of claim 2, wherein the attachment device axis has a location on the second end surface of the airfoil body a distance along the second true chord length from the leading edge point that is at least 10% of the second true chord length.

5. The airfoil of claim 2, wherein the first diameter is greater than the second diameter.

6. The airfoil of claim 1, wherein the attachment device axis is located on the first end surface of the airfoil body a distance along the first true chord length from the leading edge point that is at least 10% of the first true chord length.

7. The airfoil of claim 1, wherein the airfoil body, the first button, and the first attachment device are an integral component.

8. The airfoil of claim 1, wherein the first true chord length is equal to the second true chord length.

9. An airfoil for a gas turbine engine, the airfoil comprising:
an airfoil body having a leading edge, a trailing edge, a first end surface extending from the leading edge to the trailing edge, and a second end surface extending from the leading edge to the trailing edge and opposite the first end surface, wherein (i) a first true chord length is defined as a linear distance along the first end surface from a first leading edge point located at an intersection of the first end surface and the leading edge to a first trailing edge point located at an intersection of the first end surface and the trailing edge and (ii) a second true chord length is defined as a linear distance from a second leading edge point located at an intersection of the second end surface and the leading edge to a second trailing edge point located at an intersection of the second end surface and the trailing edge;
a first button located on the first end surface of the airfoil body, the first button having a first diameter and configured to fit within a first recess of a flow path of a gas turbine engine; and
a first attachment device extending from the first button and configured to attach to the gas turbine engine and enable rotation of the airfoil body about an attachment device axis that extends through the first attachment device, the first button, and the airfoil body, wherein the airfoil body is rotatable about the attachment device axis,
wherein the attachment device axis is located on the first end surface of the airfoil body a distance along the first true chord length from the leading edge point that is at least 10% of the first true chord length.

10. The airfoil of claim 9, further comprising:
a second button located on the second end surface of the airfoil body, the second button having a second diameter and configured to fit within a second recess of the flow path of the gas turbine engine; and
a second attachment device extending from the second button,
wherein the attachment device axis extends through the second button and the second attachment device.

11. The airfoil of claim 10, wherein the attachment device axis has a location on the second end surface of the airfoil body a distance along the second true chord length from the second leading edge point that is at least 10% of the second true chord length.

12. The airfoil of claim 9, wherein the airfoil body, the first button, and the first attachment device are an integral component.

13. The airfoil of claim 9, wherein the first diameter is greater than the second diameter.

14. The airfoil of claim 9, wherein the first true chord length is equal to the second true chord length.

15. A gas turbine engine comprising:
a variable area turbine having a variable area vane, the vane comprising:
an airfoil body having a leading edge, a trailing edge, a first end surface extending from the leading edge to the trailing edge, and a second end surface extending from the leading edge to the trailing edge and opposite the first end surface, wherein (i) a first true chord length is defined as a linear distance along the first end surface from a first leading edge point located at an intersection of the first end surface and the leading edge to a first trailing edge point located at an intersection of the first end surface and the trailing edge and (ii) a second true chord length is defined as a linear distance from a second leading edge point located at an intersection of the second end surface and the leading edge to a second trailing edge point located at an intersection of the second end surface and the trailing edge;
a first button located on the first end surface of the airfoil body, the first button having a first diameter and configured to fit within a first recess of a flow path of a gas turbine engine; and
a first attachment device extending from the first button and configured to attach to the gas turbine engine and enable rotation of the airfoil body about an attachment device axis that extends through the first attachment device, the first button, and the airfoil body, wherein the airfoil body is rotatable about the attachment device axis,
wherein the length of the first diameter is at least 15% of the first true chord length.

16. The gas turbine engine of claim 15, further comprising:
a second button located on the second end surface of the airfoil body, the second button having a second diameter and configured to fit within a second recess of the flow path of the gas turbine engine; and
a second attachment device extending from the second button,
wherein the attachment device axis extends through the second button and the second attachment device.

17. The gas turbine engine of claim 16, wherein the second diameter is at least 15% of the second true chord length.

18. The gas turbine engine of claim 16, wherein the attachment device axis has a location on the second end surface of the airfoil body a distance along the second true chord length from the leading edge point that is at least 10% of the second true chord length.

19. The gas turbine engine of claim 15, wherein the attachment device axis is located on the first end surface of the airfoil body a distance along the first true chord length from the leading edge point that is at least 10% of the first true chord length.

20. A gas turbine engine comprising:
a variable area turbine having a variable area vane, the vane comprising:
an airfoil body having a leading edge, a trailing edge, a first end surface extending from the leading edge to the trailing edge, and a second end surface extending from the leading edge to the trailing edge and opposite the first end surface, wherein (i) a first true chord length is defined as a linear distance along the first end surface from a first leading edge point located at an intersection of the first end surface and the leading edge to a first trailing edge point located at an intersection of the first end surface and the trailing edge and (ii) a second true chord length is defined as a linear distance from a second leading edge point located at an intersection of the second end surface and the leading edge to a second trailing edge point located at an intersection of the second end surface and the trailing edge;
a first button located on the first end surface of the airfoil body, the first button having a first diameter and configured to fit within a first recess of a flow path of a gas turbine engine; and
a first attachment device extending from the first button and configured to attach to the gas turbine engine and enable rotation of the airfoil body about an attachment device axis that extends through the first attachment device, the first button, and the airfoil body, wherein the airfoil body is rotatable about the attachment device axis,
wherein the attachment device axis is located on the first end surface of the airfoil body a distance along the first true chord length from the leading edge point that is at least 10% of the first true chord length.
